(19) United States
(12) Patent Application Publication
(10) Pub. No.: US 2022/0408235 A1
(43) Pub. Date: Dec. 22, 2022

(54) SYSTEMS AND METHODS FOR PROVIDING FEMTOCELL AND MACRO CELL INTERFERENCE CONNECTIVITY SOLUTIONS FOR INTERNET OF THINGS DEVICES

(71) Applicant: Verizon Patent and Licensing Inc., Basking Ridge, NJ (US)

(72) Inventors: Sachin KAMAT, East Brunswick, NJ (US); Jeremy NACER, Boca Raton, FL (US); Sudhir PATEL, Boonton, NJ (US)

(73) Assignee: Verizon Patent and Licensing Inc., Basking Ridge, NJ (US)

(21) Appl. No.: 17/304,272

(22) Filed: Jun. 17, 2021

(51) Int. Cl. H04W 8/00; H04W 60/04; H04W 76/11

(52) U.S. Cl. CPC H04W 8/005; H04W 60/04; H04W 76/11; H04W 84/042

(57) ABSTRACT

An IoT device may maintain a list of cells that fail to support features of the IoT device and may scan a designated frequency band to identify strongest cells in the designated frequency band. The IoT device may decode one or more signals from one or more of the identified strongest cells that are not included in the list and may determine, based on the decoded one or more signals, a first subset of the one or more of the identified strongest cells that support features of the IoT device and a second subset of the one or more of the identified strongest cells that fail to support features of the IoT device. The IoT device may select a particular cell of the first subset of the one or more of the identified strongest cells that support features of the IoT device and may attach to the particular cell.

### BACKGROUND

Currently, macro cells and femtocells provide radio access network (RAN) coverage for Internet of Things (IoT) devices (e.g., devices that are embedded with sensors, software, and other technologies for the purpose of connecting and exchanging data with other devices and systems over a network). Femtocells are used for in-building coverage in situations where the macro cells cannot penetrate indoors, such as in multiple dwelling units (MDUs), offices, and malls where there are challenging deployments. In some situations, the macro cells and femtocells provide different features which may not support particular IoT devices (e.g., Cat-M IoT devices, narrowband (NB)-IoT devices, and/or the like). The Cat-M IoT devices include connected vehicles, wearable devices, trackers, alarm panels, and/or the like. The NB-IoT devices include meters, sensors, and/or the like. The particular IoT devices may be unable to locate network services (e.g., rendering the particular IoT devices useless to customers) even though the particular IoT devices may be deployed within network coverage. This may occur when there is overlapping network coverage between a macro cell and a femtocell and/or when a femtocell fails to support features of the particular IoT devices. However, the overlapping network coverage may not be resolved without removing one of the coverage layers, causing customers to be impacted with throughput limitations as well as increased network interference where the overlapping occurs.

### BRIEF DESCRIPTION OF THE DRAWINGS

FIGS. 1A-1G are diagrams of an example associated with providing femtocell and macro cell interference connectivity solutions for IoT devices.

FIG. 2 is a diagram of an example environment in which systems and/or methods described herein may be implemented.

FIG. 3 is a diagram of example components of one or more devices of FIG. 2.

FIG. 4 is a flowchart of an example process for providing femtocell and macro cell interference connectivity solutions for IoT devices.

### DETAILED DESCRIPTION OF PREFERRED EMBODIMENTS

The following detailed description of example implementations refers to the accompanying drawings. The same reference numbers in different drawings may identify the same or similar elements.

Current techniques for providing network coverage to particular IoT devices consume computing resources (e.g., processing resources, memory resources, communication resources, and/or the like), networking resources, and/or other resources associated with handling customer complaints caused by inoperable IoT devices, attempting to correct the inoperable IoT devices, creating network outages to serve the inoperable IoT devices, and/or the like.

Some implementations described herein provide femtocell and macro cell interference connectivity solutions that eliminate increased network interference where overlapping occurs for IoT devices. For example, an IoT device may maintain a list of cells (e.g., femtocells and/or macro cells) that fail to support features of the IoT device (e.g., features for which the IoT is seeking) and may scan a designated frequency band to identify strongest cells (e.g., femtocells and/or macro cells) in the designated frequency band. The IoT device may analyze signals from the identified strongest cells that are not included in the list and may determine, based on the analyzed signals, a subset of the identified strongest cells that support features of the IoT device. The IoT device may select a particular cell of the subset of the identified strongest cells that support features of the IoT device and may attach to the particular cell.

In some implementations, a backend network device may receive, from a femtocell associated with an IoT device, a list of neighbor cells (e.g., femtocells and/or macro cells) of a designated frequency band, and may determine a subset of the list of neighbor cells that support features of the IoT device. The backend network device may cause identifiers of cells, included in the subset of the list of neighbor cells that support features of the IoT device, to be provided to the IoT device so that the IoT device may select and attach to a cell from the subset of the list of neighbor cells.

In this way, femtocell and macro cell interference connectivity solutions may be provided for IoT devices. For example, a femtocell and a backend network device (e.g., a server device) may autonomously identify scenarios when an IoT device cannot connect to an appropriate network and may create a feedback loop to determine a configuration of a deployment area associated with the IoT device. The feedback loop may enable the IoT device to identify and attach to a femtocell that supports features of the IoT device or to a macro cell if the femtocell does not support the features of the IoT device. Thus, implementations described herein may conserve computing resources, networking resources, and other resources that would have otherwise been consumed by handling customer complaints caused by inoperable IoT devices, attempting to correct the inoperable IoT devices, creating network outages to serve the inoperable IoT devices, and/or the like.

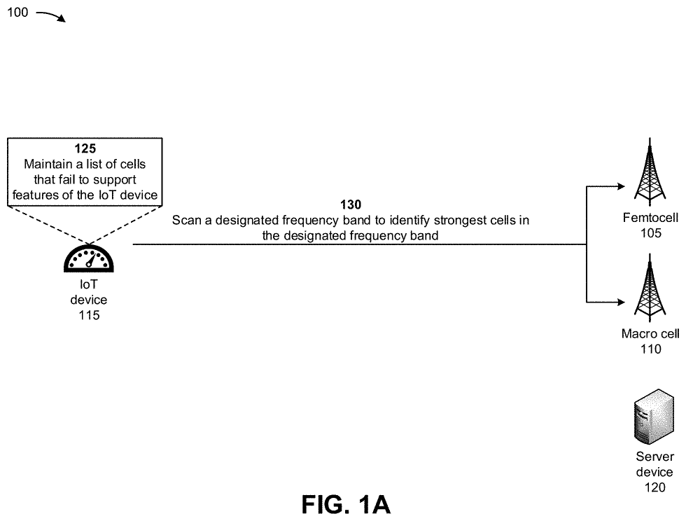

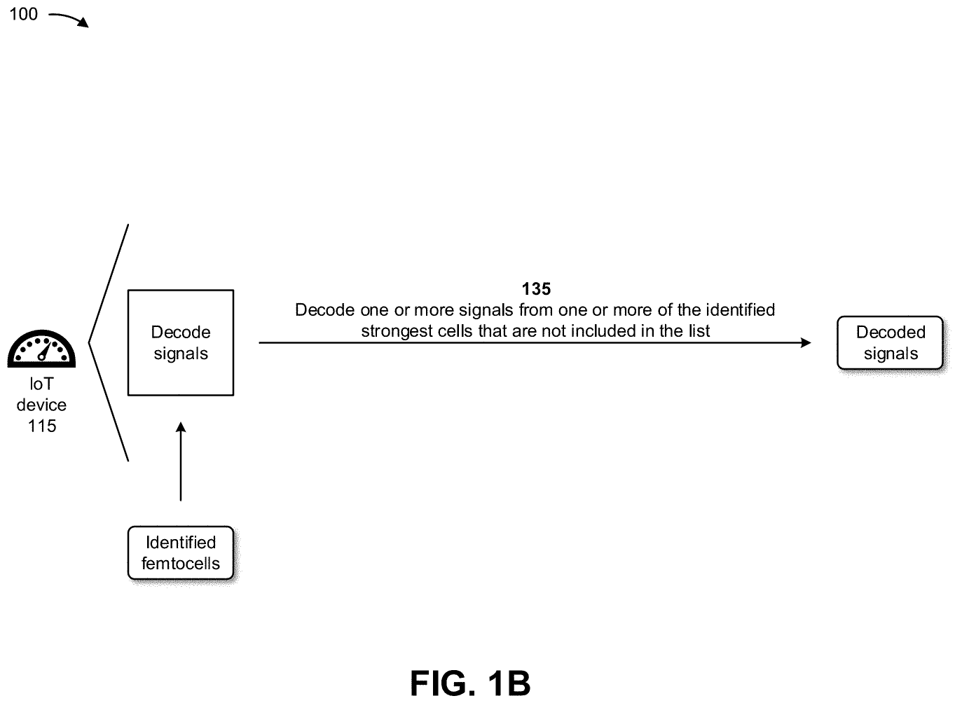

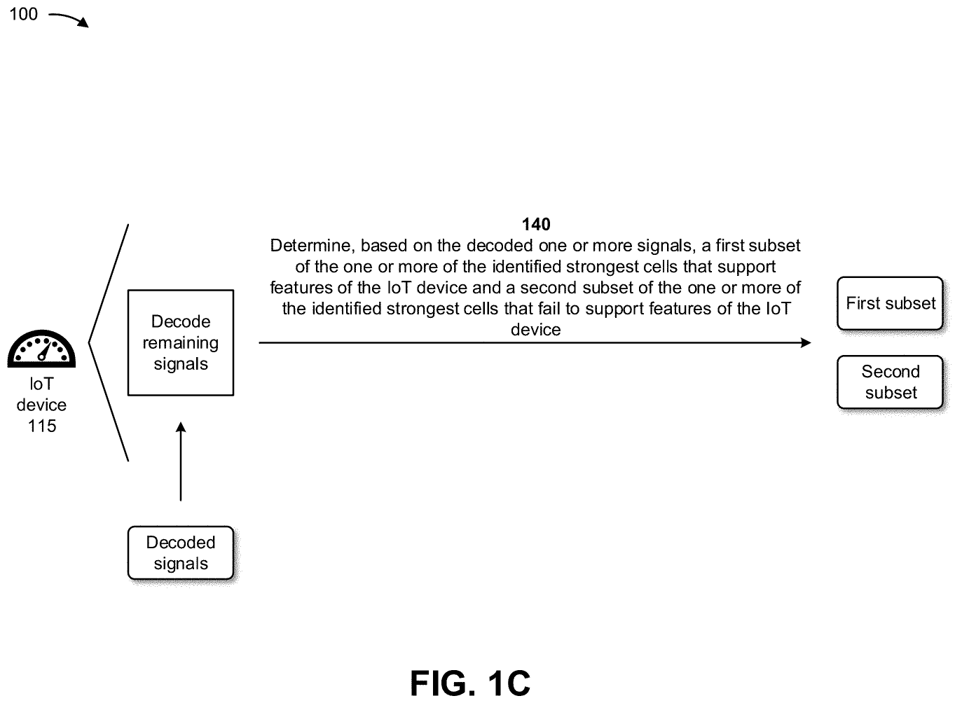

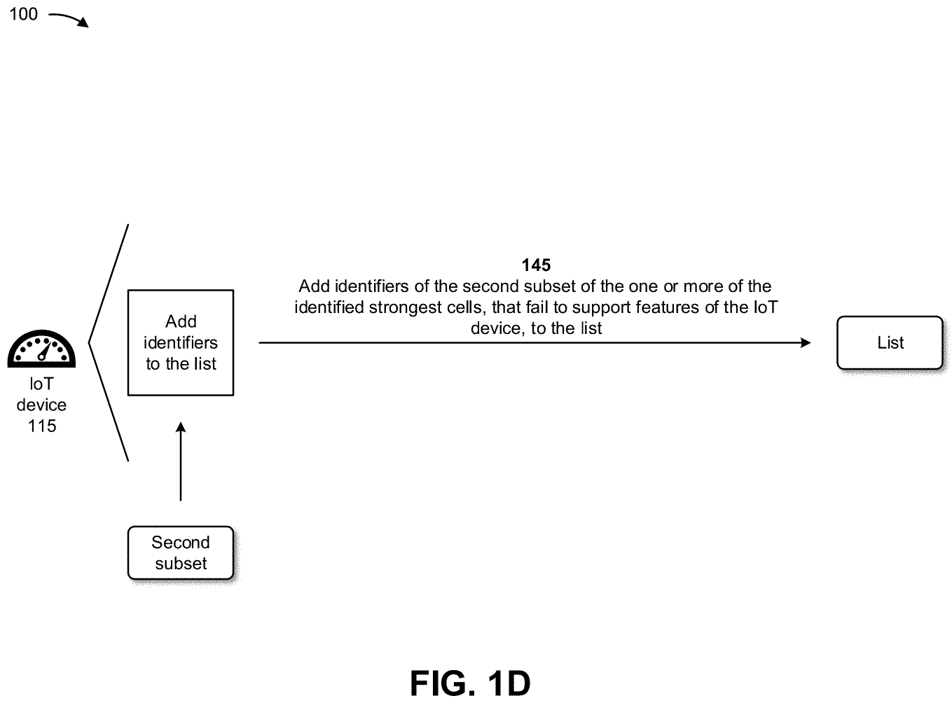

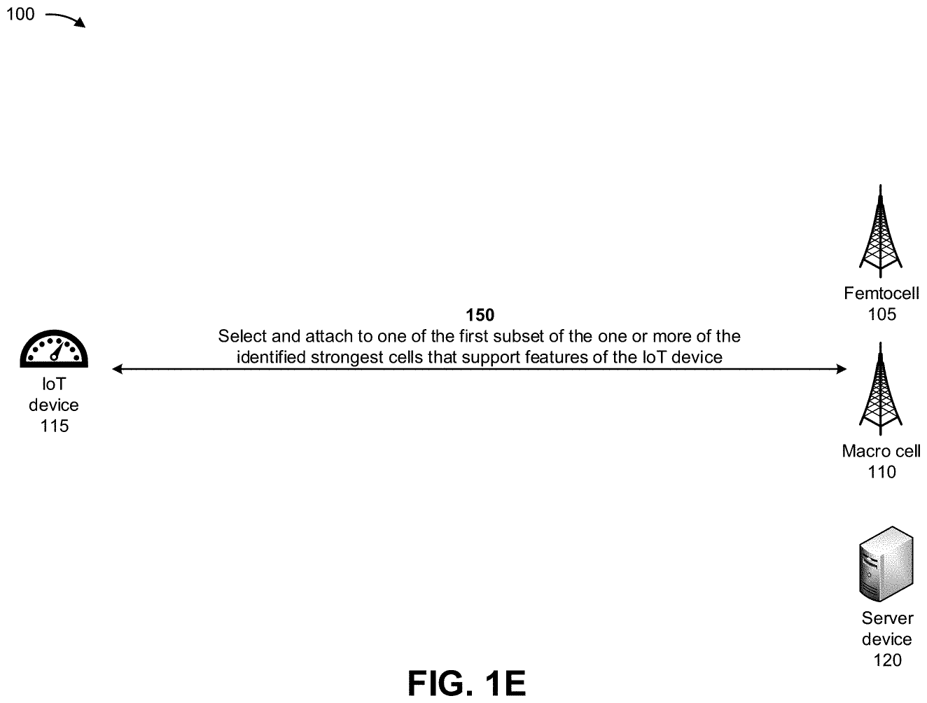

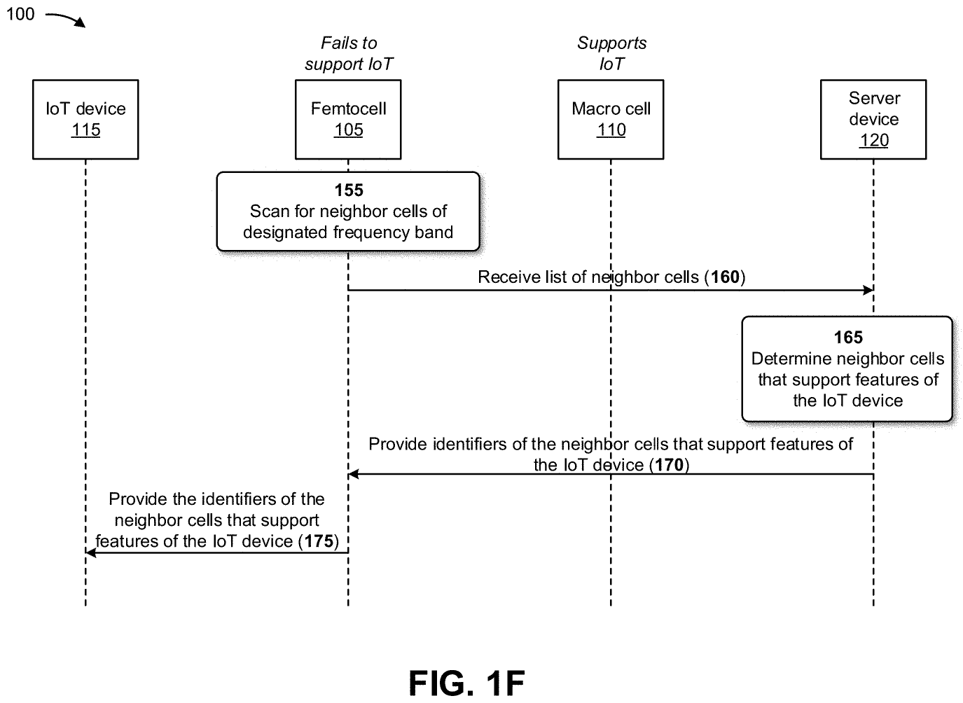

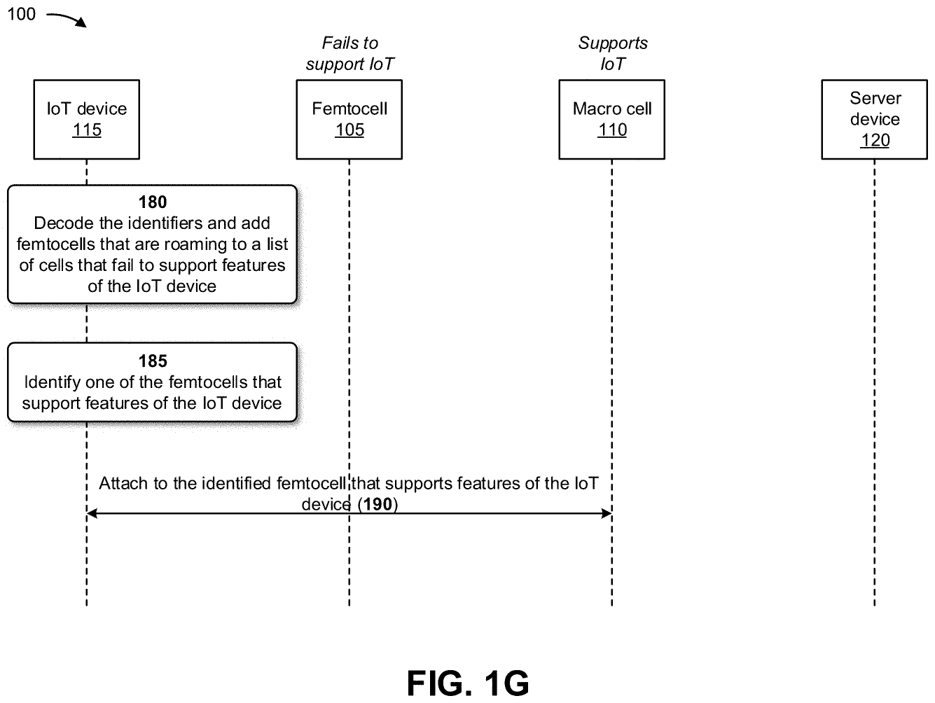

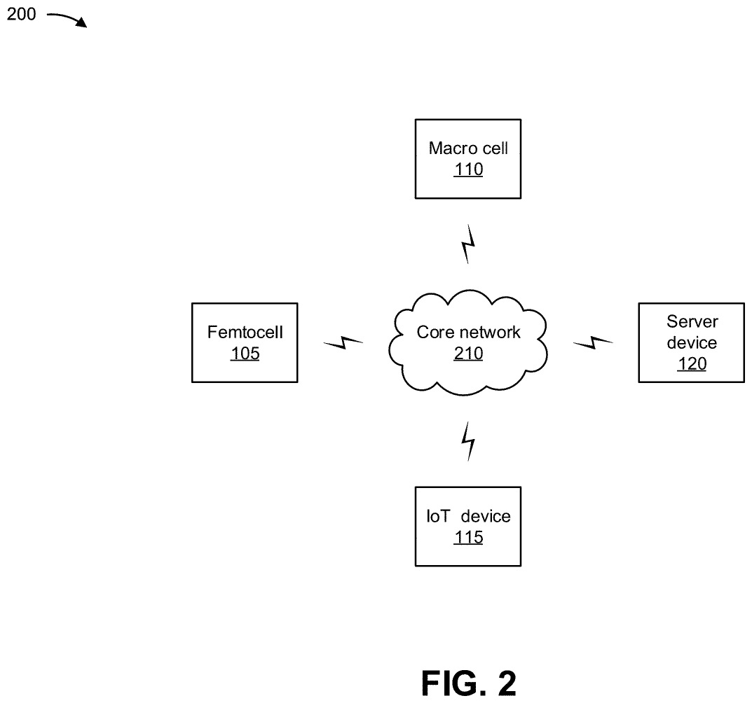

FIGS. 1A-1G are diagrams of an example 100 associated with providing femtocell and macro cell interference connectivity solutions for IoT devices. As shown in FIGS. 1A-1G, example 100 includes a femtocell 105 and a macro cell 110 associated with an IoT device 115 and a server device 120. The IoT device 115 may include a Cat-M IoT device or an NB-IoT device. Further details of the femtocell 105, the macro cell 110, the IoT device 115, and the server device 120 are provided elsewhere herein. Although certain operations are shown in FIGS. 1A-1G as being performed by the server device 120, in some implementations, the operations may be performed by another network device and the server device 120 together, by the other network device alone, and/or the like. Although FIGS. 1A-2 depict the IoT device 115, in some implementations, the IoT device 115 may be replaced with a user equipment (UE), such as a wireless communication device, a mobile phone, a user equipment, a laptop computer, a tablet computer, a wearable communication device (e.g., a smart wristwatch, a pair of smart eyeglasses, a head mounted display, or a virtual reality headset), or a similar type of device.

As shown in FIG. 1A, and by reference number 125, the IoT device 115 may maintain a list of cells (e.g., femtocells, macro cells, and/or the like) that fail to support features of the IoT device 115. For example, the IoT device 115 may be served by a femtocell 105 that fails to support features of the IoT device 115 and is inappropriate for use by the IoT device 115. In such an example, the IoT device 115 may add an identifier of the serving femtocell 105 to the list of cells that fail to support features of the IoT device 115. The IoT device 115 may be served by a macro cell 110 that fails to support features of the IoT device 115 and may add an identifier of the serving macro cell 110 to the list of cells that fail to support features of the IoT device 115. The list of cells may include identifiers (e.g., cell identifiers, physical cell identifiers, and/or the like) associated with the femtocells 105 and/or macro cells 110 that fail to support features of the IoT device 115.

In some implementations, the IoT device 115 may be served by a femtocell 105 that is a roaming public land mobile network (PLMN) and may add an identifier of the serving femtocell 105 to the list of cells that fail to support features of the IoT device 115 based on the serving femtocell 105 being a roaming PLMN.

The list of cells may provide a level of intelligence to the IoT device 115 that enables the IoT device 115 to scan for other frequencies of other femtocells 105 or other macro cells that support features of the IoT device 115. Without the list of cells, the IoT device 115 may only search for and be served by a femtocell 105 or a macro cell 110 with a strongest signal. However, if the femtocell 105 or the macro cell 110 fails to support features of the IoT device 115, the IoT device 115 will not receive service from the femtocell 105 of the macro cell 110. Thus, the list of cells provides a femtocell and macro cell interference connectivity solution that eliminates increased network interference where overlapping occurs for IoT devices, such as the IoT device 105.

In some implementations, the list of cells that fail to support features of the IoT device 115 may be stored in a memory of the IoT device 115. In some implementations, the list of cells that fail to support features of the IoT device 115 may be reset when the IoT device 115 is powered off or when a Universal Integrated Circuit Card (UICC) of the IoT device 115 is replaced. Alternatively, or additionally, the list of cells that fail to support features of the IoT device 115 may be reset after a predetermined time period (e.g., in hours, days, and/or the like).

As further shown in FIG. 1A, and by reference number 130, the IoT device 115 may scan a designated frequency band to identify strongest cells in the designated frequency band. For example, the IoT device 115 may scan a designated frequency band that identifies the femtocell 105 and the macro cell 110 as the strongest cells 105 in the designated frequency band. In some implementations, the IoT device 115 may scan another designated frequency band that identifies other femtocells 105 and/or macro cells 110 as the strongest cells in the other designated frequency band. In some implementations, the femtocell 105 may provide stronger signal than the macro cell 110, but the macro cell 110 may support features of the IoT device 115 and the femtocell 105 may not support features of the IoT device 115. In such implementations, the macro cell 110 may be selected by the IoT device 115.

As shown in FIG. 1B, and by reference number 135, the IoT device 115 may decode one or more signals from one or more of the identified strongest cells that are not included in the list of cells that fail to support features of the IoT device 115. For example, the IoT device 115 may compare identifiers of the identified strongest cells to the identifiers included in the list of cells that fail to support features of the IoT device 115. If an identifier of a particular identified strongest cell is included in the list of cells that fail to support features of the IoT device 115, the IoT device 115 may not decode a signal received from the particular identified strongest cell. In this way, the IoT device 115 may conserve computing resources associated with unnecessarily decoding the signal received from the particular identified strongest cell since the IoT device 115 should not attach to the particular identified strongest cell (e.g., which fails to support features of the IoT device 115).

However, if the identifier of the particular identified strongest cell is not included in the list of cells that fail to support features of the IoT device 115, the IoT device 115 may decode the signal received from the particular identified strongest cell. In this way, the IoT device 115 only utilizes computing resources to decode signals from the identified strongest cells that are not included in the list of cells and that support features of the IoT device 115.

As shown in FIG. 1C, and by reference number 140, the IoT device 115 may determine, based on the decoded one or more signals, a first subset of the one or more of the identified strongest cells that support features of the IoT device 115 and a second subset of the one or more of the identified strongest cells that fail to support features of the IoT device 115. For example, although the one or more signals may be associated with identified strongest cells that are not included in the list of cells that fail to support features of the IoT device 115, some of the identified strongest cells may not support features of the IoT device 115. Thus, the IoT device 115 may analyze the decoded one or more signals to determine the first subset of the one or more of the identified strongest cells that support features of the IoT device 115. The IoT device 115 may also analyze the decoded one or more signals to determine the second subset of the one or more of the identified strongest cells that fail to support features of the IoT device 115.

As shown in FIG. 1D, and by reference number 145, the IoT device 115 may add identifiers (e.g., cell identifiers, physical cell identifiers, femtocell identifiers, macro cell identifiers, and/or the like) of the second subset of the one or more of the identified strongest cells, that fail to support features of the IoT device 115, to the list of cells that fail to support features of the IoT device 115. For example, since the identified strongest cells of the second subset fail to support features of the IoT device 115, the IoT device 115 may add identifiers of the identified strongest cells of the second subset to the list of cells that fail to support features of the IoT device 115. In some implementations, the IoT device 115 may continuously update the list of cells that fail to support features of the IoT device 115 based on scanning and decoding signals received from femtocells 105 and/or macro cells 110 associated with the IoT device 115. As the list of cells that fail to support features of the IoT device 115 is updated, the IoT device 115 may decode less signals received from femtocells 105 and/or macro cells 110 associated with the IoT device 115, which may conserve computing resources of the IoT device 115.

In some implementations, the IoT device 115 may determine that a particular cell, of the first subset of the one or more of the identified strongest cells that support features of the IoT device 115, is a roaming PLMN. The IoT device 115 may add an identifier of the particular cell to the list of cells that fail to support features of the IoT device 115 based on the particular cell being a roaming PLMN.

As shown in FIG. 1E, and by reference number 150, the IoT device 115 may select and attach to one of the first subset of the one or more of the identified strongest cells that support features of the IoT device 115. For example, the IoT device 115 may select the strongest cell (e.g., the macro cell 110) from the first subset of the one or more of the identified strongest cells that support features of the IoT device 115. The IoT device 115 may then attach to the strongest cell (e.g., the macro cell 110) and may receive service via the strongest cell that supports features of the IoT device 115.

In some implementations, once the IoT device 115 attaches to the selected cell, the IoT device 115 may provide the list of cells that fail to support features of the IoT device 115 to a network device (e.g., the server device 120) associated with the IoT device 115. For example, the IoT device 115 may provide the list of cells that fail to support features of the IoT device 115 to a network device via capability information message. The capability information message may include, for example, the following syntax:

```
Capability-Container-Ext
  nonCriticalExtension
    Non CatM-NB neighbor Cell parameters
      nonCatM-NB-CellIDs
        PCI1, PCI2, PCI5
```

Where PCI1, PCI2, and PCI5 are a list of physical cell identifiers (PCIs) included in the list of cells. The network device may store the list of cells that fail to support features of the IoT device 115 and/or may share the list of cells that fail to support features of the IoT device 115 with other IoT devices 115 similar to the IoT device 115.

FIGS. 1F and 1G depict alternative or additional implementations where a network (e.g., via a network device, such as the server device 120) determine and maintain the list of cells that fail to support features of the IoT device 115. As shown in FIG. 1F, the femtocell 105 may fail to support features of the IoT device 115, and the macro cell 110 may support features of the IoT device 115.

As further shown in FIG. 1F, and by reference number 155, the femtocell 105 may scan for neighbor cells of a designated frequency band. In some implementations, the femtocell 105 may scan for the neighbor cells when the femtocell 105 is powered on. The femtocell 105 may compile a list of the neighbor cells (e.g., which may include other femtocells 105, the macro cell 110, and/or other macro cells 110) based on scanning for the neighbor cells of a designated frequency band. The list of neighbor cells may include identifiers (e.g., cell identifiers, physical cell identifiers, and/or the like) associated with the neighbor cells of the designated frequency band.

As further shown in FIG. 1F, and by reference number 160, the server device 120 may receive the list of the neighbor cells from the femtocell 105. The server device 120 may store the list of the neighbor cells in a data structure associated with the server device 120.

As further shown in FIG. 1F, and by reference number 165, the server device 120 may determine the neighbor cells, provided in the list of the neighbor cells, that support features of the IoT device 115. For example, the server device 120 may determine a subset of the list of neighbor cells that support features of the IoT device 115. In some implementations, the server device 120 may analyze the list of the neighbor cells and may identify neighbor cells that support features of the IoT device 115. The server device 120 may include identifiers of such neighbor cells in the subset of the list of neighbor cells that support features of the IoT device 115.

In some implementations, the server device 120 may analyze the list of the neighbor cells and may identify neighbor cells that fail to support features of the IoT device 115 and are inappropriate for use by the IoT device 115. The server device 120 may not include identifiers of such neighbor cells in the subset of the list of neighbor cells that support features of the IoT device 115. In some implementations, the server device 120 may analyze the list of the neighbor cells and may identify neighbor cells that are roaming PLMNs. The server device 120 may not include identifiers of such neighbor cells in the subset of the list of neighbor cells that support features of the IoT device 115.

As further shown in FIG. 1F, and by reference numbers 170 and 175, the server device 120 may provide the identifiers of the neighbor cells that support features of the IoT device 115 to the femtocell 105, and the femtocell 105 may provide the identifiers to the IoT device 115. For example, the server device 120 may provide, to the femtocell 105, the subset of the list of neighbor cells that support features of the IoT device 115. The femtocell 105 may provide, to the IoT device 115, the subset of the list of neighbor cells that support features of the IoT device 115. In some implementations, the femtocell 105 may provide the subset of the list of neighbor cells to the IoT device 115 via a session information block (SIB). The SIB may include, for example, the following syntax:

```
CatM-NB neighbor Cell parameters
  CatM-NB-CellIDs
    PCI3, PCI4, PCI6
```

Where PCI3, PCI4, and PCI6 are a list of PCIs included in the subset of the list of neighbor cells.

As shown in FIG. 1G, and by reference number 150, the IoT device 115 may decode the identifiers of the neighbor cells that support features of the IoT device 115 and may determine whether any of the neighbor cells are roaming PLMNs based on the decoded identifiers. As further shown by reference number 175, the IoT device 115 may add identifiers of the neighbor cells that are roaming PLMNs to a list of cells that fail to support features of the IoT device 115. The IoT device 115 may utilize the list of cells that fail to support features of the IoT device 115 as described above in connection with FIGS. 1A-1E.

As further shown in FIG. 1G, and by reference number 185, the IoT device 115 may identify one of the neighbor cells that support features of the IoT device 115. In some implementations, the IoT device 115 may identify a strongest cell from the neighbor cells that support features of the IoT device 115. For example, the IoT device 115 may identify the macro cell 110 from the neighbor cells that support features of the IoT device 115.

As further shown in FIG. 1G, and by reference number 190, the IoT device 115 may attach to the identified cell that supports features of the IoT device 115 (e.g., the macro cell 110) and may receive service via the identified macro cell 110. In some implementations, once the IoT device 115 attaches to the identified macro cell 110, the IoT device 115 may provide the list of cells that fail to support features of the IoT device 115 to a network device (e.g., the server device 120) associated with the IoT device 115.

In this way, femtocell and macro cell interference connectivity solutions may be provided for the IoT device 115. For example, the femtocell 105 and the server device 120 may autonomously identify scenarios when the IoT device 115 cannot connect to an appropriate network and may create a feedback loop to determine a configuration of a deployment area associated with the IoT device 115. The feedback loop may enable the IoT device 115 to identify and attach to a femtocell 105 that supports features of the IoT device 115. Thus, implementations described herein may conserve computing resources, networking resources, and other resources that would have otherwise been consumed by handling customer complaints caused by inoperable IoT devices 105, attempting to correct the inoperable IoT devices 105, creating network outages to serve the inoperable IoT devices 105, and/or the like.

As indicated above, FIGS. 1A-1G are provided examples. Other examples may differ from what is described with regard to FIGS. 1A-1G. The number and arrangement of devices shown in FIGS. 1A-1G are provided as examples. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

FIG. 2 is a diagram of an example environment 200 in which systems and/or methods described herein may be implemented. As shown in FIG. 2, environment 200 may include the femtocell 105, the macro cell 110, the IoT device 115, the server device 120, and/or a core network 210. Devices and/or elements of the environment 200 may interconnect via wired connections and/or wireless connections.

The femtocell 105 includes one or more devices capable of transferring traffic, such as audio, video, text, and/or other traffic, destined for and/or received from the IoT device 115. For example, the femtocell 105 may include a femtocell base station, an access point, a transmit receive point (TRP), a radio access node, a microcell base station, a picocell base station, and/or another network entity capable of supporting wireless communication.

The macro cell 110 includes one or more devices capable of transferring traffic, such as audio, video, text, and/or other traffic, destined for and/or received from the IoT device 115. For example, the macro cell 110 may include an eNodeB (eNB) associated with a long term evolution (LTE) network that receives traffic from and/or sends traffic to a core network, a gNodeB (gNB) associated with a RAN of a fifth generation (5G) network, a base transceiver station, a radio base station, a base station subsystem, a cellular site, a macro cell base station, and/or another network entity capable of supporting wireless communication.

The IoT device 115 includes one or more devices capable of receiving, generating, storing, processing, and/or providing information, as described elsewhere herein. The IoT device 115 may include a communication device. For example, the IoT device 115 may include a wireless communication device, a mobile phone, a laptop computer, a tablet computer, a gaming console, a set-top box, a wearable communication device (e.g., a smart wristwatch, a pair of smart eyeglasses, a head mounted display, or a virtual reality headset), a meter, a sensor, a connected vehicle, a tracker, an alarm panel, or a similar type of device.

The server device 120 includes one or more devices capable of receiving, generating, storing, processing, providing, and/or routing information, as described elsewhere herein. The server device 120 may include a communication device and/or a computing device. For example, the server device 120 may include a device, such as an application device, a client device, a web device, a database device, a host device, a proxy device, a virtual device (e.g., executing on computing hardware), a multi-access edge computing (MEC) device, a device reported attribute server, a diagnostic/management server, a cloud compute server, or a device in a cloud computing system. In some implementations, the server device 120 includes computing hardware used in a cloud computing environment.

The core network 210 may include a core network or a RAN that includes one or more of the femtocells 105 that take the form of eNBs, gNBs, among other examples, via which the IoT device 115 communicates with the core network 210. The core network 210 may include one or more wired and/or wireless networks. For example, the core network 210 may include a cellular network (e.g., a 5G network, an LTE network, a third generation (3G) network, a code division multiple access (CDMA) network), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, among other examples, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

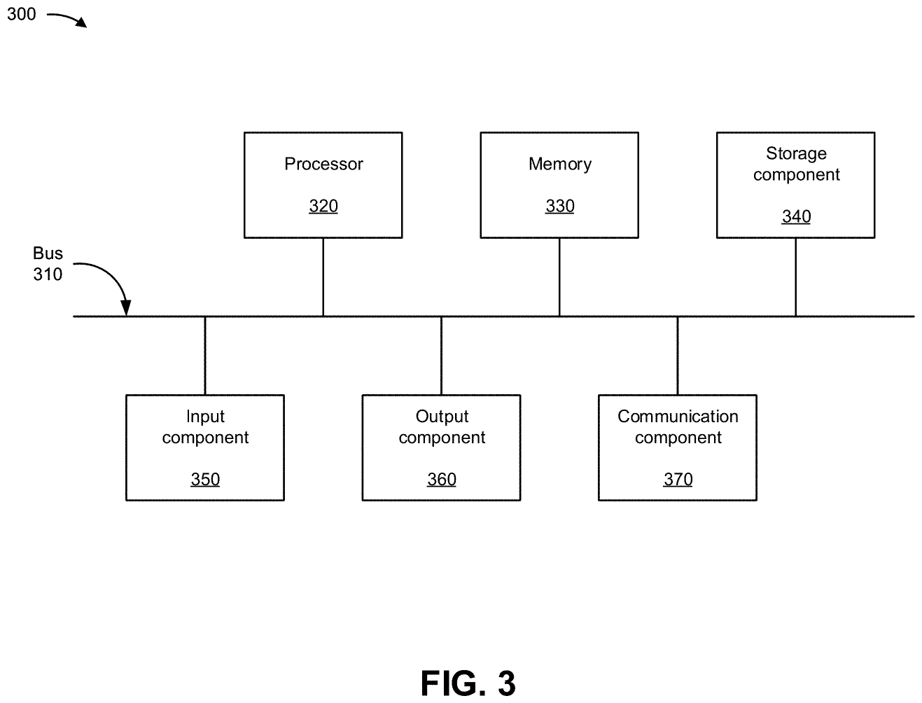

FIG. 3 is a diagram of example components of one or more devices of FIG. 2. The one or more devices may include a device 300, which may correspond to the femtocell 105, the IoT device 115, and/or the server device 120. In some implementations, the femtocell 105, the IoT device 115, and/or the server device 120 may include one or more devices 300 and/or one or more components of the device 300. As shown in FIG. 3, the device 300 may include a bus 310, a processor 320, a memory 330, a storage component 340, an input component 350, an output component 360, and a communication component 370.

The bus 310 includes a component that enables wired and/or wireless communication among the components of device 300. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform a function. The memory 330 includes a random-access memory, a read only memory, and/or another type of memory (e.g., a flash memory, a magnetic memory, and/or an optical memory).

The storage component 340 stores information and/or software related to the operation of device 300. For example, the storage component 340 may include a hard disk drive, a magnetic disk drive, an optical disk drive, a solid-state disk drive, a compact disc, a digital versatile disc, and/or another type of non-transitory computer-readable medium. The input component 350 enables device 300 to receive input, such as user input and/or sensed inputs. For example, the input component 350 may include a touch screen, a keyboard, a keypad, a mouse, a button, a microphone, a switch, a sensor, a global positioning system component, an accelerometer, a gyroscope, and/or an actuator. The output component 360 enables device 300 to provide output, such as via a display, a speaker, and/or one or more light-emitting diodes. The communication component 370 enables the device 300 to communicate with other devices, such as via a wired connection and/or a wireless connection. For example, the communication component 370 may include a receiver, a transmitter, a transceiver, a modem, a network interface card, and/or an antenna.

The device 300 may perform one or more processes described herein. For example, a non-transitory computer-readable medium (e.g., the memory 330 and/or the storage component 340) may store a set of instructions (e.g., one or more instructions, code, software code, and/or program code) for execution by the processor 320. The processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

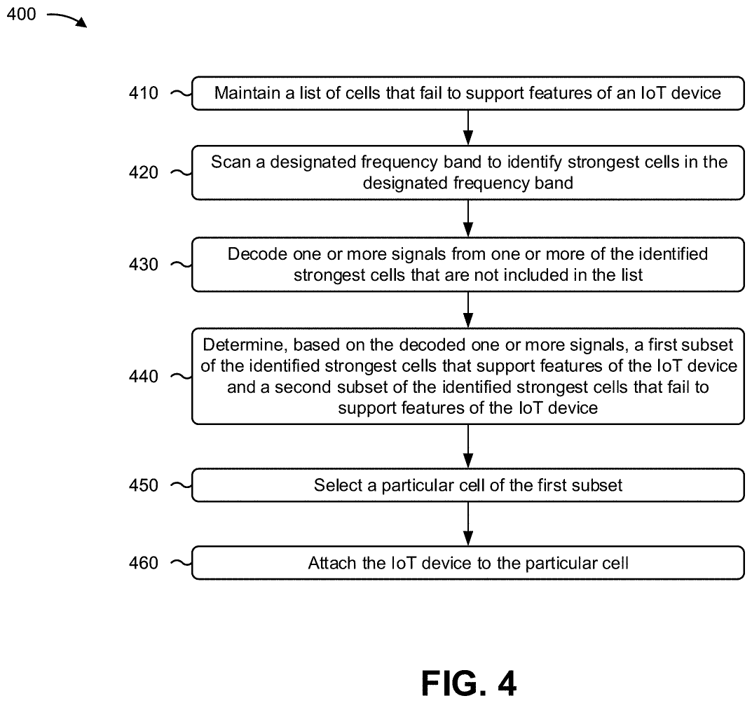

FIG. 4 is a flowchart of an example process 400 for providing femtocell and macro cell interference connectivity solutions for IoT devices. In some implementations, one or more process blocks of FIG. 4 may be performed by a device (e.g., the IoT device 115). In some implementations, one or more process blocks of FIG. 4 may be performed by another device or a group of devices separate from or including the device, such as a femtocell (e.g., the femtocell 105) and/or server device (e.g., the server device 120). Additionally, or alternatively, one or more process blocks of FIG. 4 may be performed by one or more components of the device 300, such as the processor 320, the memory 330, the storage component 340, the input component 350, the output component 360, and/or the communication component 370.

As shown in FIG. 4, process 400 may include maintaining a list of cells that fail to support features of the IoT device (block 410). For example, the IoT device may maintain a list of cells that fail to support features of the IoT device, as described above. In some implementations, the list of cells is stored in a memory of the IoT device. In some implementations, the IoT device includes one of a Cat-M IoT device or a narrowband-IoT device.

As further shown in FIG. 4, process 400 may include scanning a designated frequency band to identify strongest cells in the designated frequency band (block 420). For example, the IoT device may scan a designated frequency band to identify strongest cells in the designated frequency band, as described above.

As further shown in FIG. 4, process 400 may include decoding one or more signals from one or more of the identified strongest cells that are not included in the list (block 430). For example, the IoT device may decode one or more signals from one or more of the identified strongest cells that are not included in the list, as described above.

As further shown in FIG. 4, process 400 may include determining, based on the decoded one or more signals, a first subset of the one or more of the identified strongest cells that support features of the IoT device and a second subset of the one or more of the identified strongest cells that fail to support features of the IoT device (block 440). For example, the IoT device may determine, based on the decoded one or more signals, a first subset of the one or more of the identified strongest cells that support features of the IoT device and a second subset of the one or more of the identified strongest cells that fail to support features of the IoT device, as described above.

As further shown in FIG. 4, process 400 may include selecting a particular cell of the first subset of the one or more of the identified strongest cells that support features of the IoT device (block 450). For example, the IoT device may select a particular cell of the first subset of the one or more of the identified strongest cells that support features of the IoT device, as described above. In some implementations, the particular cell is a macro cell.

As further shown in FIG. 4, process 400 may include attaching the IoT device to the particular cell (block 460). For example, the IoT device may attach the IoT device to the particular cell, as described above.

Process 400 may include additional implementations, such as any single implementation or any combination of implementations described below and/or in connection with one or more other processes described elsewhere herein.

In some implementations, process 400 includes adding identifiers of the second subset of the one or more of the identified strongest cells, that fail to support features of the IoT device, to the list of cells. In some implementations, process 400 includes one of resetting the list of cells when the IoT device is powered off or resetting the list of cells after a predetermined time period.

In some implementations, process 400 includes determining that another particular cell, of the first subset of the one or more of the identified strongest cells that support features of the IoT device, is a roaming public land mobile network, and adding an identifier of the other particular cell to the list of cells based on the other particular cell being a roaming public land mobile network. In some implementations, process 400 includes providing the list of cells to a network associated with the IoT device.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
maintaining, by an Internet of Things (IoT) device, a list of cells that fail to support features of the IoT device;
scanning, by the IoT device, a designated frequency band to identify strongest cells in the designated frequency band;
decoding, by the IoT device, one or more signals from one or more of the identified strongest cells that are not included in the list;
determining, by the IoT device and based on the decoded one or more signals, a first subset of the one or more of the identified strongest cells that support features of the IoT device and a second subset of the one or more of the identified strongest cells that fail to support features of the IoT device;
selecting, by the IoT device, a particular cell of the first subset of the one or more of the identified strongest cells that support features of the IoT device; and
attaching the IoT device to the particular cell.

2. The method of claim 1, further comprising:
adding identifiers of the second subset of the one or more of the identified strongest cells, that fail to support features of the IoT device, to the list of cells.

3. The method of claim 1, wherein the particular cell is a macro cell.

4. The method of claim 1, further comprising one of:
resetting the list of cells when the IoT device is powered off; or
resetting the list of cells after a predetermined time period.

5. The method of claim 1, further comprising:
determining that another particular cell, of the first subset of the one or more of the identified strongest cells that support features of the IoT device, is a roaming public land mobile network; and
adding an identifier of the other particular cell to the list of cells based on the other particular cell being a roaming public land mobile network.

6. The method of claim 1, further comprising:
providing the list of cells to a network associated with the IoT device.

7. The method of claim 1, wherein the IoT device includes one of a Cat-M IoT device or a narrowband-IoT device.

8. A network device, comprising:
one or more processors configured to:
receive, from a femtocell associated with an Internet of Things (IoT) device, a list of neighbor cells of a designated frequency band;
determine a subset of the list of neighbor cells that support features of the IoT device; and
cause identifiers of cells, included in the subset of the list of neighbor cells that support features of the IoT device, to be provided to the IoT device,
wherein the identifiers cause the IoT device to select a macro cell from the subset of the list of neighbor cells and to attach to the macro cell.

9. The network device of claim 8, wherein the IoT device includes one of a Cat-M IoT device or a narrowband-IoT device.

10. The network device of claim 8, further comprising:
receiving, from the IoT device, information identifying the neighbor cells that support features of the IoT device,
wherein the one or more processors, to determine the subset of the list of neighbor cells that support features of the IoT device, are configured to:
determine the subset of the list of neighbor cells that support features of the IoT device based on the information identifying the neighbor cells that support features of the IoT device.

11. The network device of claim 8, wherein the identifiers cause the IoT device to decode the identifiers to identify the neighbor cells.

12. The network device of claim 8, wherein the network device includes one of a multi-access edge computing device or a device management server device.

13. The network device of claim 8, wherein the femtocell fails to support features of the IoT device.

14. The network device of claim 8, wherein the list of neighbor cells includes cell identifiers or physical cell identifiers associated with the neighbor cells.

15. A non-transitory computer-readable medium storing a set of instructions, the set of instructions comprising:
one or more instructions that, when executed by one or more processors of an Internet of Things (IoT) device that includes one of a Cat-M IoT device or a narrowband-IoT device, cause the IoT device to:
maintain a list of cells that fail to support features of the IoT device;
scan a designated frequency band to identify strongest cells in the frequency band;
decode one or more signals from one or more of the identified strongest cells that are not included in the list;
determine, based on the decoded one or more signals, a first subset of the one or more of the identified strongest cells that support features of the IoT device and a second subset of the one or more of the identified strongest cells that fail to support features of the IoT device;
select a particular cell of the first subset of the one or more of the identified strongest cells that support features of the IoT device; and
attach the IoT device to the particular cell.

16. The non-transitory computer-readable medium of claim 15, wherein the one or more instructions further cause the IoT device to:
add identifiers of the second subset of the one or more of the identified strongest cells, that fail to support features of the IoT device, to the list of cells.

17. The non-transitory computer-readable medium of claim 15, wherein the list of cells is stored in a memory of the IoT device.

18. The non-transitory computer-readable medium of claim 15, wherein the one or more instructions further cause the IoT device to one of:
reset the list of cells when the IoT device is powered off; or
reset the list of cells after a predetermined time period.

19. The non-transitory computer-readable medium of claim 15, wherein the one or more instructions further cause the IoT device to:
determine that another particular cell, of the first subset of the one or more of the identified strongest cells that support features of the IoT device, is a roaming public land mobile network; and
add an identifier of the other particular cell to the list of cells based on the other particular cell being a roaming public land mobile network.

20. The non-transitory computer-readable medium of claim 15, wherein the one or more instructions further cause the IoT device to:
provide the list of cells to a network associated with the IoT device.
